(19) United States
(12) Patent Application Publication
(10) Pub. No.: US 2008/0051971 A1
(43) Pub. Date: Feb. 28, 2008

(54) METHOD AND APPARATUS FOR PROVIDING SAFE SPEED OF A VEHICLE AND USING THE INFORMATION

(75) Inventor: Seo Dae SUNG, Pyeongtaek-si (KR)

Correspondence Address: BIRCH STEWART KOLASCH & BIRCH, PO BOX 747, FALLS CHURCH, VA, 22040-0747, US

(73) Assignee: LG ELECTRONICS INC., Seoul (KR)

(21) Appl. No.: 11/842,745

(22) Filed: Aug. 21, 2007

(30) Foreign Application Priority Data
Jul. 21, 2006 (KR) 10-2006-0078644

(51) Int. Cl. G08G 1/0968; G05D 13/02; G06F 19/00

(52) U.S. Cl. 701/93; 701/117

(57) ABSTRACT

The present invention provides a method and device for providing a safe driving speed for a road segment containing a dangerous element such as slipperiness of road surface. One method according to an embodiment of the present invention decodes from received traffic information signals a safe speed used to limit the speed of a vehicle on a road segment and location information about the corresponding segment. When the current location information indicates the road segment, the speed of the vehicle is forced to be reduced below the received safe speed.

This Non-provisional application claims priority under 35 U.S.C. §119(a) on Patent Application No. 10-2006-0078644 filed in Republic of Korea on Aug. 21, 2006, the entire contents of which are hereby incorporated by reference.

### BACKGROUND OF THE INVENTION

1. Field of the Invention

The present invention is related to a method and apparatus for providing road traffic information and using the provided information.

2. Description of the Related Art

Today, with the advancement of digital signal processing and communications technology, radio and TV broadcast signals are provided gradually in the form of digital data. As signals are provided in a digital form, a variety of information such as news, stock, weather, and traffic information are now supplementing TV or radio broadcasting signals.

In particular, necessity for traffic information is constantly increasing with the increment of the number of vehicles in downtown areas, the number of vehicles during holidays, and so on. Accordingly, methods for providing traffic information as auxiliary information via satellite, terrestrial broadcast, or mobile communications network are under development.

Provision of traffic information as above is directed to help a driver choose an appropriate road or path by providing current traffic information (for example, light traffic, congestion, delay, etc). A means for helping a driver drive safety in a dangerous road segment coping with any change of road conditions such as slipperiness of road surface has not been prepared yet.

### SUMMARY OF THE INVENTION

One objective of the present invention is to provide a method and apparatus for providing a driver on a road with a safe speed about a dangerous road segment.

Another objective of the present invention is to provide a method and apparatus for controlling the driving speed of a vehicle in accordance with a provided safe speed.

Another objective of the present invention is to provide a method and apparatus for providing safe speed information, which address the limitations and disadvantages associated with the related art.

One method for encoding traffic information according to one aspect of the present invention comprises creating event information including a safe speed to limit a speed of a vehicle on a road segment, creating location information about the road segment, and creating a traffic information message including the event information and location information.

One method for decoding traffic information according to another aspect of the present invention comprises extracting a traffic information message from received signals and extracting from the extracted traffic information message event information including a safe speed to limit a speed of a vehicle on a road segment and location information about die road segment.

One apparatus for decoding traffic information according to another aspect of the present invention comprises a decoder for extracting and decoding from received a traffic information message event information including a safe speed to limit a speed of a vehicle on a road segment and location information about the road segment; a receiver for receiving information about a current location; and a controller for controlling a driving speed of a vehicle based on the safe speed and location information decoded by the decoder and a current location obtained from the receiver.

Another apparatus for providing a user with traffic information according to another aspect of the present invention comprises a decoder for extracting from received signals event information including a safe speed to limit a speed of a vehicle on a road segment and location information about the road segment; a controller for controlling a speed of a vehicle based on the extracted information at the request of a user; and an interface unit including a button having a function of requesting a speed of a vehicle to be controlled based on received information.

A yet another apparatus for providing a user with traffic information according to another aspect of the present invention comprises a decoder for extracting from received signals event information including a safe speed to limit speed of a vehicle on a road segment and location information about the road segment and a controller for controlling a speed of a vehicle based on the extracted information at the request of a user, wherein the controller, when the speed of the vehicle is not set to be controlled based on received information, provides an interface unit with a button having a function of requesting a speed of a vehicle to be controlled based on received information.

In one embodiment according to the present invention, when a road becomes slippery, for example, in the case of a rainy, snowy, or icy road, the safe speed is set for the corresponding road segment and transmitted as traffic information.

In one embodiment according to the present invention, the safe speed is carried by a component for transferring information about surface conditions and adhesion of a road.

In one embodiment according to the present invention, if a reference (e.g., weight or height) exists whereby the safe speed is determined, information on the reference is transferred together with the safe speed.

In one embodiment according to the present invention, the location information includes either longitude and latitude coordinates corresponding to a start and end point of the road segment or link information about the road segment.

In another embodiment according to the present invention, the location information includes longitude and latitude coordinates corresponding to a start and end point of the road segment and information about a link to which the road segment belongs.

In one embodiment according to the present invention, when the speed of a vehicle is reduced in a specific road segment according to the safe speed, a driver is notified of the speed reduction by video and/or audio information.

In one embodiment according to the present invention, if a vehicle gets out of a road segment specified by the location information white the speed of the vehicle is under the safe speed, the speed of the vehicle is restored to the one before the speed reduction and the driver is notified of the restoration by video and/or audio information.

In one embodiment according to the present invention, when additional reference information about the safe speed is received, based on a ratio of configuration information of a vehicle corresponding to the reference information, an actual safe speed is calculated from the safe speed, which is used as a reference to adjust the driving speed of a vehicle.

In one embodiment according to the present invention, when an operation for controlling the speed of a vehicle based on received information is set as inactive in environment configuration of the apparatus, the button is provided to the interface unit and at the same time, the operation for controlling the speed of a vehicle based on received information is set as active in the environment configuration.

According to another aspect, the present invention provides a device for providing traffic information in a moving object, comprising: a receiver to obtain information on a current location of the moving object, and to receive a traffic information message including safe speed information for a road segment and location information of the road segment; and a controller to compare the current location of the moving object with the received location information, and to selectively and automatically vary an actual speed of the moving object according to the safe speed information if the current location of the moving object belongs to the toad segment identified in the received location information.

These and other objects of the present application will become more readily apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from tins detailed description.

### BRIEF DESCRIPTION OF THE DRAWINGS

The accompanying drawings, which are included to provide a further understanding of the invention, illustrate the preferred embodiments of the invention, and together with the description, serve to explain the principles of the present invention. In the drawings:

FIG. 1 illustrates an example of a network system through which traffic information including safe speed information is provided according to the present invention;

FIG. 2A illustrates an example of a format of traffic information transmitted wirelessly according to the present invention;

FIG. 2B illustrates an example of a syntax after which an RTM event container or a TPEG location container of FIG. 2A is composed;

FIG. 3A illustrates an example of a transfer structure of information about road conditions included in an RTM event container according to one embodiment of the present invention centering around the transfer of safe speed information;

FIG. 3B illustrates an example of a transfer structure of location information about a road segment to which a safe speed is assigned according to one embodiment of the present invention, the location information being included in a TPEG location container;

FIG. 3C illustrates an example of a transfer structure of location information about a road segment to which safe speed is assigned according to another embodiment of the present invention, the location information being included in a TPEG location container;

FIG. 4A illustrates an example of a syntax of a safe speed carried by an RTM component of FIG. 3A;

FIG. 4B illustrates an example of a syntax of link information carried by an RTM component of FIG. 3C;

FIG. 5A illustrates a block diagram of a navigation terminal that receives traffic information transmitted from a server in accordance with one embodiment of the present invention;

FIG. 5B illustrates an example of a screen display of a navigation terminal where a request button for speed control based on a received safe speed is displayed in accordance with one embodiment of the present invention;

FIG. 6 illustrates a flow diagram of a method for speed control based on a received safe speed in accordance with one embodiment of the present invention; and

FIG. 7 illustrates an example of a virtual link shape to demonstrate usefulness of link information for determining whether a current segment corresponds to a road segment to which safe speed is assigned in accordance with an embodiment of the present invention.

### DETAILED DESCRIPTION OF THE PREFERRED EMBODIMENTS

Hereinafter, according to the present invention, embodiments will be described in detail with reference to appended drawings.

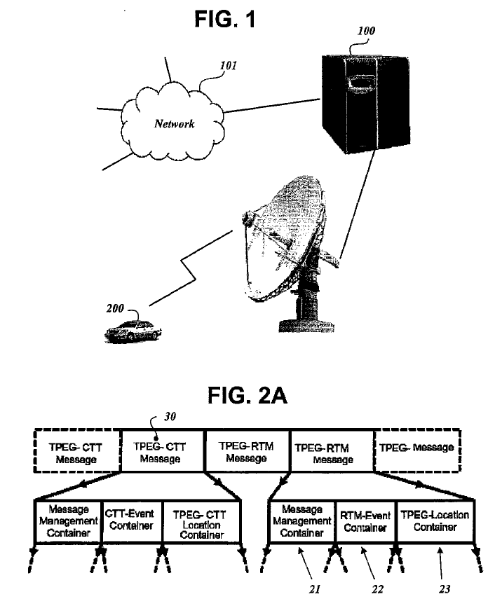

FIG. 1 illustrates a network through which traffic information is provided according to the present invention. As shown in FIG. 1, a traffic information providing server or device 100 in a broadcast station reconfigures information about congestion and road conditions collected from various sources (e.g., operator input, information received from another server through a network 101 or probe cars) with respect to each road segment, and transmits the reconfigured information wirelessly so that a traffic information receiving terminal (e.g., a navigation terminal) installed in a car, terminal or any other device 200 can receive the information.

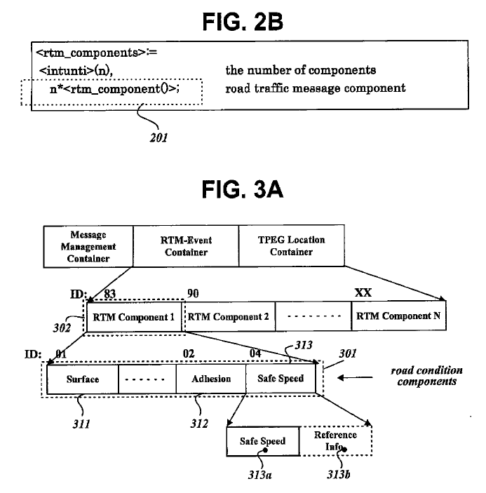

As shown in FIG. 2, a format of traffic information transmitted wirelessly from the traffic information providing server 100 to the device 200 is composed of a sequence of message segments (hereinafter, a message segment is referred to as a TPEG (Transport Protocol Export Group) message). The message segment in the segment sequence which transfers road traffic information, namely a TPEG-RTM (Road Traffic Message) comprises a message management container 21, an RTM event container 22, and a TPEG location container 23. Other message segments in the segment sequence can have traffic information other than the information about the road conditions, and can be, for example a TPEG-CTT (Congestion and T′ravel-Time information) message 30 for transferring traffic (congestion) information of a road. Since providing the traffic information through a message segment is not related to the present invention, a further description thereupon will be omitted.

The message management container 21 carries information about date, time, and occurrence time of a message, and the RTM event container 22 carries event information about road conditions requiring attention. In particular, the RTM event container carries 22 information about a safe speed in accordance with the present invention. Meanwhile, the TPEG location container 23 carries information about a road segment to which the safe speed is assigned.

Since the present invention provides a safe speed according to surface conditions of a road, particularly to the degree of slipperiness, the following description deals with the safe speed, composition and transfer of information about a road segment to which the safe speed is assigned, and an operation according to the composed information. For a technique or composition of additional information used in the various embodiments of the present invention but not described here, one of various already known methods for providing road traffic information can be used.

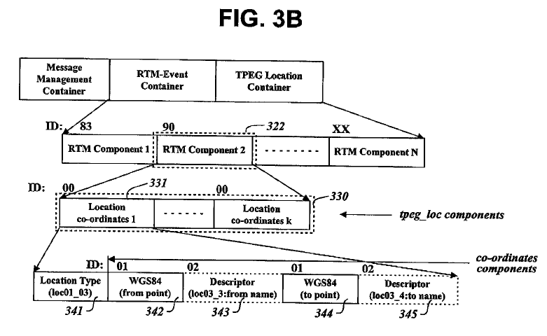

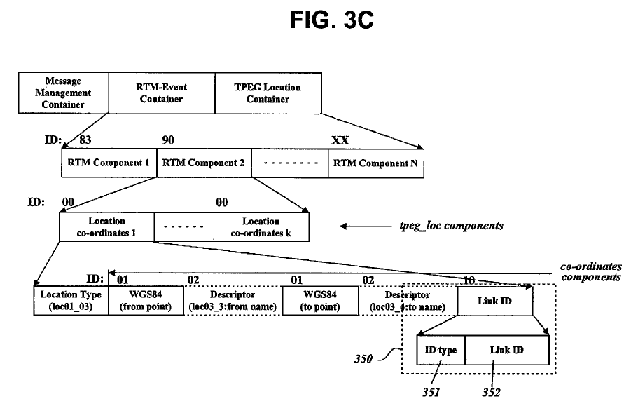

As shown in FIG. 2B, both the RTM event container 22 and the TPEG location container 23 preferably includes one or more than one RTM component 201. An identifier of 0x8X (X=0˜9) is used for each RTM component carrying road condition information, whereas an identifier of 0x90 is used in the case of carrying location information. As shown in FIG. 3A, in one embodiment according to the present invention, a safe speed according to the degree of slipperiness of a road (or other data) provided in accordance with the present invention is provided in an RTM component of an identifier 0x83. Since transmission through a component of a different identifier in a form different from what are described below can be immediately understood by those skilled in the art, transmitting the safe speed through a different component in a different form should also be considered to belong to the scope of the present invention.

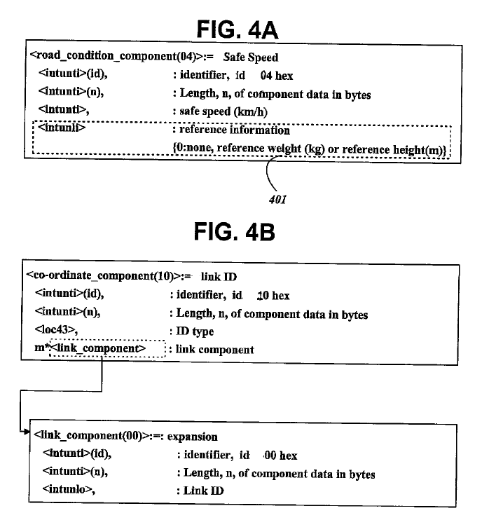

When die server 100 judges surface conditions of a particular road segment to be dangerous due to rain, snow, ice, or unevenness on a toad surface, etc., a variety of information including the safe speed for the road segment is loaded into more than one toad condition component 301 and packed in an RTM component 302 of an identifier 0x83, thus being transmitted. To be more specific, in the RTM component 302, a road condition component 311 of an identifier 0x01 carries information about surface conditions of a dangerous road segment (for example, unevenness, potholes, pavement ratio, rock falls, etc.) and information about the strength of surface conditions of the road (for example, slight, medium, severe, very severe, etc.). A road condition component 312 of an identifier 0x02 carries information about factors influencing friction between tires of a vehicle and a road (for example, oil spillage, snowfall, sleet, rain, etc.) and information about the magnitude of the influencing factors. The server 100 puts either of the two components above 311, 312 (or both) in the RTM component 302 according to the road conditions. In the example of FIG. 3A, a road condition component 313 of an identifier 0x04 is configured according to the syntax described in FIG. 4A by incorporating information about the safe speed determined after road conditions specified in the above component and is transmitted as part of the traffic information transmitted from the server 100 to the device 200.

The safe speed information (e.g., safe speed) contained in the road condition component 313 of an identifier 0x04 and thus transmitted by the server 100 can be varied depending on surface conditions of a road; for example, when a safe speed is set with respect to surface unevenness, the safe speed is so determined that a driver can recognize the surface conditions of the toad before driving. When a safe speed is set with respect to a friction of a road, namely, slipperiness, it is so determined that a driver can drive safely through the road without skidding. The safe speed as above is calculated automatically by the server 100 according to a method determined by collected information about the surface conditions or friction of a road. As an example of calculating such safe speed with respect to slipperiness, the safe speed of the present invention can be set to be 50% of a speed Vc (V_{c}=\sqrt{μgR}, where μ is a friction coefficient due to slipperiness of a road surface, g is acceleration of gravity, and R is radius of the corresponding segment) at which centrifugal force due to the curvature of the corresponding segment equals centripetal force due to the friction of a road surface. Alternatively, the safe speed for a particular segment according to the present invention may be entered manually by an operator of the server 100 and provided in the form of FIG. 3A.

In one embodiment, the component 313 carrying the safe speed for a dangerous segment may not necessarily be transmitted along with the aforementioned component 311 for surface conditions of a road or component 312 for adhesion state of a road.

If necessary, the server 100 can include in the component for safe speed 313 reference information 313B in addition to the safe speed 313A for a current dangerous segment. When the reference information 313B is not necessary, a value of ‘0’ can be recorded in the corresponding field 401 of FIG. 4A. The reference information can be a reference weight or height after which the transmitted safe speed is calculated. The terminal/device 200 which receives the safe speed can further calculate the actual safe speed of the corresponding vehicle with respect to the received safe speed based on a ratio of weight or height of the center of mass of the vehicle, which is set previously in the terminal, to the received reference information or square root of the ratio.

The server 100 transmits location information about a dangerous road segment to which the safe speed is assigned through a TPEG location container (e.g., the container 23 in FIG. 2A). FIG. 3B illustrates an example of a transfer structure of location information about a road segment to which the safe speed is assigned according to one embodiment of the present invention. As shown in FIG. 3B, more than one TPEG location component (Tpeg_loc_component) 330 is contained in an RTM component 322 of an identifier 0x90 and thus transmitted by the server 100 to the device 200. Each TPEG location component 330 carries location coordinates of an identifier 0x00, where more than one coordinates component is loaded.

Each coordinates component (e.g., 331) can have varied information according to the identifier, such as identifying information, longitude and latitude coordinate information, vertex information, type information, or description information of a link, etc. A link is a road unit corresponding to a road segment without a branch point inside. Since the present invention is related to transmitting the location information about a road segment of safe speed, a description is given primarily for doe structure of transmitting the location information of the road segment, which is illustrated in FIG. 3B. In this regard, only those related to the transmission of location information about a road segment of safe speed are described specifically, whereas descriptions about the transmission of other information as above are omitted.

As shown in FIG. 3B, a coordinates component 331 for transmitting information about a dangerous road segment carries information about location type 341, longitude and latitude coordinates of a start point of a dangerous segment 342, and longitude and latitude coordinates of an end point of a dangerous segment 344. In this example, a value indicating a segment, e.g., 3, is recorded in the information about location type 341. In the notation employed for description of figures or invention, ‘locNN_kk’ (‘NN’ and ‘kk’ are both numerals) denotes the value of ‘kk’ in a table specified by ‘locNN’. (The table is die one commonly defined among the server 100 and terminals communicating therewith or the one applied to a program in accordance with the definition.) The nearing of the value of ‘kk’ is interpreted as defined in locNN table. For example, ‘loc01_03’ in the example of FIG. 3B is so used under an assumption that 03 is defined to denote a road segment in loc01 table. A value in a form of ‘locNN_kk’ not mentioned particularly in the description of the present invention uses kk value and its meaning as predefined in locNN table.

The coordinates component 331 can additionally have text information 343, 345 describing start and end points, and other information.

Interrelationship between information about road conditions transmitted by the previously described RTM component and location information of a road segment transmitted by a coordinates component is established by the order of each component and transmission order of the corresponding information within each component. For example, road condition component(s) within an RTM component of a first identifier 0x83 is associated with a first coordinates component within an RTM component of a first identifier 0x90.

In another embodiment according to the present invention, as shown in FIG. 3C, the location information about a dangerous segment can further include information (link information) 350 about a link to which the segment belongs. FIG. 4B illustrates an example of a syntax about such link information which is included additionally. The link information in the coordinates component of an identifier 0x10 configured according to the syntax as shown in FIG. 4B includes ID type 351 and link ID 352. Link ID 352 is information denoted by a number or code, enabling a single link to be uniquely identified across the entire region of traffic service. Link type 351 is a value to denote which service company or country uses which allocation system of link IDs. In the example of FIG. 3C, if the entire segment of a link specified by the link ID turns out to be a dangerous segment, longitude and latitude information of a start and end point for specifying a segment may not be included in die location coordinates. Information about the ID of a link and location and shape thereof can be recorded or provided already in a terminal (e.g., device 200) receiving the traffic information or can be transmitted through a separate TPEG location container.

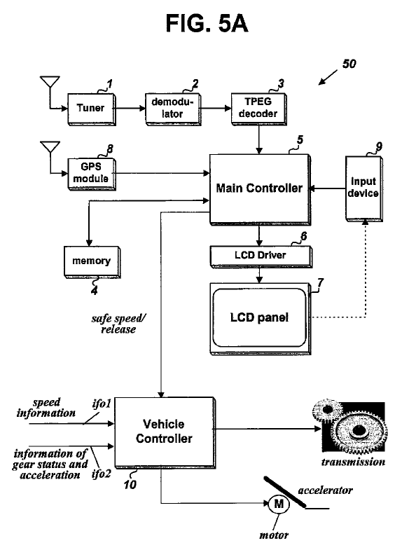

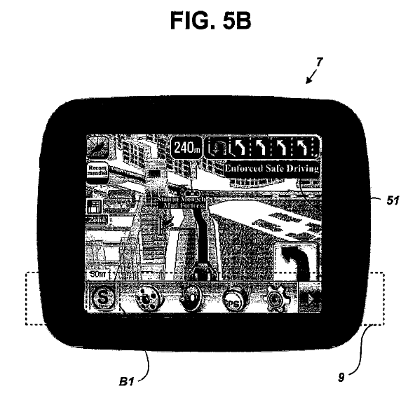

FIG. 5A is a block diagram of a terminal 50 that receives traffic information transmitted from the server 100, which is composed as described above, in accordance with one embodiment of the invention. The terminal 50 can be the device 200 or part of the device 200 or other suitable component. In this example, the terminal 50 is provided within a vehicle, and the terminal 50 is operatively coupled with the vehicle.

The terminal 50 of FIG. 5A comprises a tuner 1 for resonating at the required frequency band of received traffic information signals and subsequently outputting modulated traffic information signals, a demodulator 2 for outputting traffic information signals by demodulating the modulated traffic information signals, a TPEG decoder 3 for decoding the demodulated traffic information signals and acquiring traffic information including a variety of congestion information and information about dangerous segments, a GPS module 8 for calculating a current position (e.g., latitude, longitude, and altitude) by receiving signals from a plurality of satellites, a storage unit or means 4 for embedding various graphic data and storing required information temporarily, an input device 9 for receiving a user's input, a main controller 5 for controlling a screen display based on the user's input, current location, and acquired traffic information and calculating information required for speed control and delivering the information to a vehicle controller 10, an LCD or other display panel 7 for displaying video and other images, an LCD (display) driver 6 for feeding driving signals to the LCD panel 7 according to graphic data for display, and a vehicle controller 10 controlling a transmission and an accelerator pedal of the vehicle according to detected speed and received information for speed control. The input device 9 can be an interface equipped on the LCD panel 7, e.g., a touch screen, a keypad, etc. The terminal 50 may include other components, and all components of the terminal 50 are operatively coupled and configured.

The tuner 1 resonates at signals that the server 100 transmits, and the demodulator 2 demodulates and outputs the resonating signals in a predetermined way. The TPEG decoder 3 then extracts from the input demodulation signals a TPEG message which is transmitted with the structure of FIGS. 2A and 2B, FIGS. 3A and 3B or 3C, FIGS. 4A and 4B, and stores the TPEG message temporarily. Each of the temporarily stored TPEG messages is interpreted and necessary information and/or control data relevant to the content of the message are delivered to the main controller 5. Although the TPEG decoder 3 delivers a variety of information (e.g., current congestion of each link, etc.) and/or control data to the main controller 5, since the present invention is related to providing safe speed information for a dangerous segment and corresponding operations of a terminal according thereto, descriptions in the following are given centering around the operations in association with controlling the safe speed of the vehicle.

The TPEG decoder 3 extracts date/time and message occurrence time from a message management container of each TPEG message, determines from information of ‘message element’ whether a succeeding container is an RTM event container, and delivers the acquired information from road condition components 301 within the message container to the main controller 5. The TPEG decoder 3 also obtains, from a succeeding TPEG location component, location information corresponding to road condition component(s) contained in the currently transferred RTM component. Information about the road conditions contained in other components within an RTM event component is also delivered to the man controller 5 and relevant processing operations are carried out (e.g., an operation of displaying information about obstacles, surface conditions, and slipperiness of a particular road segment on the LCD panel 7). Since the above operations do not necessarily have direct relevance to die present invention, further description about processing such information is not provided for the sake of brevity.

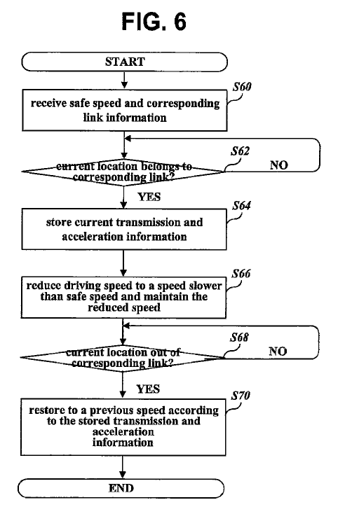

FIG. 6 illustrates a flow diagram of a method for speed control based on safe speed information in accordance with one embodiment of the present invention. The method of FIG. 6 is described below as being implemented in the device of FIG. 5A, but can be implemented by other suitable device.

Referring to FIG. 6, the main controller 5, when it is found that information about the safe speed is contained in the information obtained from the TPEG decoder 3, first determines location information about a segment to which the safe speed is assigned, e.g., longitude and latitude coordinates of a start and end point of die segment (S60). The location information, after recognition, is compared continuously with the longitude and latitude coordinates of a current location received from the GPS module 8 (S62). If the current coordinates of longitude and latitude lies in a road segment specified by the longitude and latitude coordinates of the start and end point, the main controller 5 provides a safe speed assigned to the segment for the vehicle controller 10. For instance, the main controller 5 accesses the safe speed assigned to the corresponding segment provided in the traffic information received from the server 100.

Then the vehicle controller 10, at the time of receiving the safe speed, compares the received safe speed with a currently detected speed of the vehicle (ifo1). If the current speed of the vehicle is found to be faster than the received safe speed, the vehicle controller 10 stores information (ifo2) about the current state of transmission and accelerator pedal (S64) and controls the transmission and/or accelerator pedal of the vehicle appropriately, thereby reducing the speed of the vehicle to a speed slower than the received safe speed and maintaining the reduced speed (S65).

In another embodiment according to the present invention, the above operation of reducing the current speed of a vehicle under the received safe speed can be selectively activated according to a driver's choice by an operation of a soft button B1 provided through an interface as shown in FIG. 5B. In this example, the soft button B1 is a touch-screen type button as shown in FIG. 5B, the function of which is displayed on the LCD panel 7 and choice thereof is also done on the panel; or the soft button can be a physical key on the input device 9, where the function carried out at the selection of the button is selectively changed and information notifying of the function due to the selection of the button at a particular time is displayed at the corresponding position on the LCD panel 7. When an operation of speed control due to safe speed is carried out selectively as above, the main controller 5, at the user's request for activation through the soft button, displays the activation state, e.g., guide information 51 such as ‘enforced safe driving’ on the LCD panel 7.

In another embodiment according to the present invention, instead of providing a button for requesting driving under a safe speed, or along with providing die button, activation of ‘driving under safe speed’ can be controlled by setting as active or inactive in the configuration of the terminal 50. In other words, if the user selects ‘driving under safe speed’ item as active on the configuration screen provided by the main controller 5, guide information 51 is displayed as shown in FIG. 5B and while in a road segment to which the safe speed is assigned, the operation of driving under the safe speed is carried out forcibly as described above, whereas the same operation is not carried out if the user selects the inactive state. In one example according to the present invention, if ‘driving under safe speed’ is set as inactive in the configuration, the main controller 5 provides a soft button B1 for requesting activation of ‘driving under safe speed’. At the activation of this button, the main controller 5 changes the ‘driving under safe speed’ item to the active state in the configuration and at the same time, carries out the operations described with reference to FIG. 6.

Meanwhile, as described above, in the case of reducing the vehicle speed under the received safe speed, the reduction thereof is displayed on the LCD panel 7 in a form of high visibility, e.g., in a form of flickering text. If a speaker is installed, guide can be done by voice (a sound source stored in a digital form). Also, both visual and audio alerts can be provided to the user regarding the reduction of the vehicle speed.

While driving the vehicle under the safe speed in accordance with the reduction operation discussed above, the main controller 5 continuously monitors whether a current location received from the GPS module 8 gets out of the specified dangerous segment (a segment between longitude and latitude coordinates of the received start and end point) (S68). When the current location is determined to be out of the corresponding segment, the main controller 5 deliver a release signal to the vehicle controller 10. According thereto, the vehicle controller 10 controls the transmission and accelerator pedal to gradually turn to the recorded states thereof, i.e., to resume to the previous vehicle speed according to the stored transmission and acceleration information of step S64 (S70). That is, when the current location is no longer the corresponding segment, the vehicle returns to the speed it was on prior to the speed reduction operation. Upon completion of the control/adjustment above (or before starting an operation of restoring to the recorded states of transmission and accelerator pedal), the driver can be notified of the completion visually and/or audibly.

In another embodiment according to the present invention, instead of adjusting an accelerator pedal, a throttle valve adjusting the amount of fuel injected to an engine of the vehicle can be directly controlled. In the present embodiment, in the case of forced adjustment of speed, by releasing a coupling part between an accelerator pedal and a throttle valve, possibility of driving over the safe speed by the driver in a dangerous road segment can be removed. As a variation, other ways of changing a speed of the vehicle can also be used.

According to the embodiment of FIG. 3C, in the case of receiving the information (e.g., information 350) about a link ID along with the location information about a start and end point of a dangerous segment, it is additionally determined whether the coordinate of a current location received from the GPS module 8 belong to the link specified by the received link ID. Information about the shape of a link specified by the link ID 352 (a set of longitude and latitude coordinates of vertexes of a link) is either stored in the storage means 4 beforehand or provided by the server 100 and then stored in the storage means 4. In this way, by determining additionally whether a current location of the vehicle belongs to a link specified by the link ID, possibility of making a wrong decision about a safe speed segment in a highly winding road segment can be effectively removed.

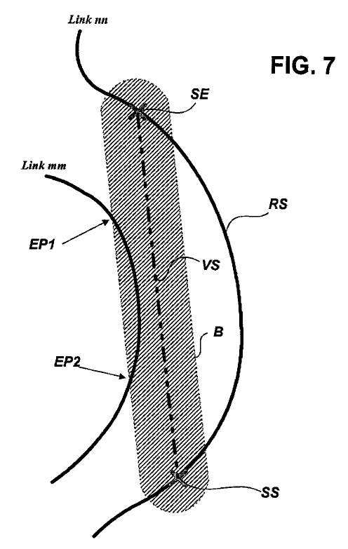

For example, as shown in FIG. 7, when a particular segment (RS:SS˜SE) of a first link ‘nn’ has turned into an icy road due to a local cause such as frozen burst of a water pipe, a virtual segment VS is assigned to the segment RS based on longitude and latitude coordinates thereof. Considering a position error of longitude and latitude coordinates calculated from GPS signals, a virtual segment to which a safe speed is assigned becomes a B region. In such circumstances, if a vehicle driving along a second link ‘mm’ enters into the B region through EP1 or EP2 point, the vehicle is determined to belong to the dangerous segment and the driving speed of the vehicle can be forced to be reduced down to the safe speed. At this moment, however, if the received link ID of a dangerous segment is checked as discussed above, since the ID of a current link is ‘mm’ whereas the link ID received for the dangerous segment is ‘nn’, the vehicle is correctly determined to not belong to the dangerous segment and consequently, forced adjustment of driving speed is not applied to the vehicle.

When the reference information (e.g., 313B in FIG. 3A) exists in the information received from the TPEG decoder 3, the main controller 5 can calculate a ratio of the reference information to currently set corresponding information (e.g., weight of a vehicle or height of center of mass measured from the surface) and apply die received safe speed multiplied by the calculated ratio as the actual safe speed of the corresponding vehicle, after which the speed control as described above is carried out. In other words, when the value of received reference information is R and currently set corresponding information is CR, the actual safe speed “Vas” employed for speed control of the corresponding vehicle according to an embodiment of the present invention becomes

$${V}_{as} = \frac{R}{CR} {V}_{S}$$

(where Vs is the received safe speed) and is delivered to the vehicle controller 10. Instead of a ratio of reference information to the corresponding information, a square root or cubic toot of the ratio can also be utilized to calculate the actual safe speed of the vehicle. That is to say,

$${V}_{as} = \sqrt{\frac{R}{CR} {V}_{S}} or {V}_{as} = \sqrt[3]{\frac{R}{CR} {V}_{S}}$$

can be utilized alternatively. The above calculations amount only to simple examples of calculating an actual safe speed to apply from a received safe speed based on reference information and actually set corresponding information. Thus various other already known methods can also be utilized to calculate an appropriate ratio value.

As to the corresponding information of the reference information set in the main controller 5, a driver can manually input the corresponding numerical values. Alternatively, the main controller 5 can provide a screen for the driver to choose a vehicle model among previously known ones, the number of passengers, sex, age, and seat position of each passenger. Weight of the vehicle and/or height of center of mass of the vehicle according to the chosen information are then automatically calculated and set, thereby being used for the calculation of the actual safe speed discussed above.

Although controlling the speed of a vehicle has been discussed above, the present invention can be applied to controlling a speed of other moving objects on roads or other guided paths.

Accordingly, the embodiments of the present invention described in detail in the above effectively and automatically increase or decrease a speed of a vehicle according to the road condition information and/or other traffic information. As a result, die present invention can prevent traffic accidents which can be taken place in a dangerous road segment due to the driver's lack of care or excessive self-confidence about driving, thereby reducing loss of lives and property.

The foregoing description of a preferred embodiment of the present invention has been presented for purposes of illustration. Thus, those skilled in the art may utilize the invention and various embodiments with improvements, modifications, substitutions, or additions within the spirit and scope of the invention as defined by the following appended claims.

What is claimed is:

1. A method for encoding traffic information, comprising:
creating event information including a safe speed to limit a speed of a vehicle on a road segment;
creating location information about the road segment; and
creating a traffic information message including the event information and the location information.

2. The method of claim 1, wherein the event information further includes reference information to which the safe speed is applied.

3. The method of claim 2, wherein the reference information includes weight information and/or height information.

4. The method of claim 1, wherein the location information includes longitude and latitude coordinates of a start and end point of the road segment.

5. The method of claim 1, wherein the location information includes information about a link to which the road segment belongs.

6. A method for decoding traffic information, comprising:
extracting a traffic information message from a received signal; and
extracting from the extracted traffic information message, event information including a safe speed to limit a speed of a vehicle on a road segment and location information of the road segment.

7. The method of claim 6, further comprising:
obtaining current location information; and
adjusting the speed of the vehicle to a speed slower than the safe speed if the obtained current location belongs to the road segment.

8. The method of claim 7, further comprising:
obtaining current location information at the adjusted speed slower than the safe speed, and restoring the speed of the vehicle to a speed prior to the adjusting if the obtained current location is out of the road segment.

9. The method of claim 6, wherein the extracted event information further includes reference information to which the safe speed is applied.

10. The method of claim 9, wherein the reference information includes weight information and/or height information.

11. The method of claim 6, wherein the extracted location information includes longitude and latitude coordinates of a start and end point of the road segment.

12. The method of claim 6, wherein the extracted location information includes information about a link to which the road segment belongs.

13. An apparatus for decoding traffic information, comprising:
a decoder to extract, from at least one received traffic information message, event information including a safe speed to limit a speed of a vehicle on a road segment and location information of the road segment, and to decode the extracted information;
a receiver to obtain information on a current location of the vehicle; and
a controller to control the speed of the vehicle based on the safe speed and the location information decoded by the decoder and the information on the current location obtained from the receiver.

14. The apparatus of claim 13, wherein if the current location belongs to the road segment, the controller stores information associated with a current driving speed of the vehicle and makes the driving speed of the vehicle slower than the safe speed, and then, if the obtained current location is out of the road segment at the slower speed, the controller adjusts the driving speed of the vehicle to a speed specified by the stored information associated with the driving speed.

15. The apparatus of claim 13, wherein the controller notifies a driver about the speed adjustment of the vehicle through an output unit when the driving speed of the vehicle is controlled according to the safe speed.

16. The apparatus of claim 15, wherein information outputted through the output unit is visual and/or audible information.

17. The apparatus of claim 13, wherein if reference information on the safe speed is further decoded from the event information, the controller computes an actual safe speed of the vehicle from the received safe speed based on a ratio of preset information of the vehicle corresponding to the reference information to the reference information, and uses the computed actual safe speed as a reference for adjusting a driving speed of the vehicle.

18. The apparatus of claim 13, wherein the decoded location information includes longitude and latitude coordinates of a start and end point of the road segment.

19. The apparatus of claim 13, wherein the decoded location information includes information about a link to which the road segment belongs.

20. An apparatus for providing a user with traffic information, comprising:
a decoder to extract, from a received signal, event information including a safe speed to limit a speed of a vehicle on a road segment and location information on the road segment;
a controller to control the speed of the vehicle based on the extracted information according to a request of a user; and
an interface unit to receive the request of the user for controlling the speed of the vehicle based on received information.

21. The apparatus of claim 20, wherein the interface unit includes a button, and when the button is chosen, the controller outputs through an output unit guide information indicating that the speed of the vehicle is being controlled based on the received information.

22. An apparatus for providing a user with traffic information, comprising:
a decoder to extract, from a received signal, event information including a safe speed to limit a speed of a vehicle on a road segment and location information on the road segment; and
a controller to control the speed of the vehicle based on the extracted information according to a request of a use,
wherein in a condition that the speed of the vehicle is not controlled based on received information, the controller provides an interface unit with a button having a function of requesting a speed of the vehicle to be controlled based on the received information.

23. The apparatus of claim 22, wherein the button comprises a physically fixed key and a text string indicating the function of the key.

24. The apparatus of claim 22, wherein the button comprises a touch area on an output unit, and a text string indicating the function to be carried out when the touch area is touched, the text string being displayed on the touch area.

25. The apparatus of claim 22, wherein the controller, along with providing the button for the interface unit, sets an operation mode for controlling the speed of the vehicle based on the received information to active in an environment configuration of the apparatus.

26. A device for providing traffic information in a moving object, comprising:
a receiver to obtain information on a current location of the moving object, and to receive a traffic information message including safe speed information for a road segment and location information of the road segment; and
a controller to compare the current location of the moving object with the received location information, and to selectively and automatically vary an actual speed of the moving object according to the safe speed information if the current location of the moving object belongs to the road segment identified in the received location information.
